(19) United States
(12) Patent Application Publication
(10) Pub. No.: US 2006/0249949 A1
(43) Pub. Date: Nov. 9, 2006

(54) Multi-Functional, Easily Changeable Self-Adherent Label Incorporating Thermo Chromic Inks

(76) Inventor: Robert G. M. Fortune, Scottsdale, AZ (US)

Correspondence Address: THE LUTHER LAW FIRM, 12198 E. COLUMBINE DR., SCOTTSDALE, AZ, 85259, US

(21) Appl. No.: 11/423,703

(22) Filed: Jun. 12, 2006

Related U.S. Application Data
(63) Continuation-in-part of application No. 11/175,107, filed on Jul. 5, 2005.
(60) Provisional application No. 60/671,190, filed on Apr. 14, 2005.

(51) Int. Cl. B42D 15/00

(52) U.S. Cl. 283/72

(57) ABSTRACT

A polylaminated, waterproof, thermally-sensitive label has a waterproof base that is adhesive on its outer surface and printable on its inner surface; an advertising image printed on the inner surface; a printable covering that overlays the advertising image; a layer of thermochromic ink on the printable covering such that the thermochromic ink is opaque at room temperature but is translucent at increased temperature; and a waterproof layer designed to overlay and protect the thermochromic ink. The labels are designed to fit within the confines of a urinal and to act as a target for the user. The labels are easily applied and removed and are intended for use in moist or wet environments. Also disclosed is a method of advertising. The method includes providing a label comprising a plastic layer that is adhesive on one surface and printable on its second surface; an advertising image or slogan printed on the second surface, a printable covering that overlays the advertising image, a layer of thermochromic ink such that the thermochromic ink is opaque at room temperature but is translucent at increased temperature, and a waterproof layer designed to overlay the thermochromic ink; placing the label on exercise equipment or on food boxes, where its display can change with the desired temperature; and replacing the label periodically to coincide with new promotional messages.

### RELATED PATENT APPLICATIONS

This application is a continuation in part of U.S. patent application Ser. No. 11/175,107, filed Jul. 5, 2005, now pending, and claims the benefit of U.S. Provisional Application No. 60/671,190, filed Apr. 14, 2005.

### BACKGROUND

A recognized conceptual model for creating a successful advertisement or marketing campaign is the AIDA model: (1) get Attention; (2) hold Interest; (3) arouse Desire, and (4) obtain Action. Although many advertisements capture the audience's attention, very few hold interest, arouse desire, and obtain action, often because these advertisements compete against numerous other advertisements and environmental distractions (“noise”).

Retail and service companies spend extraordinary amounts of money to produce and display advertisements that reach a large target audience and promote interest, such as the television commercials that are developed specifically for airing during the Super Bowl. The cost of such advertisements and marketing campaigns is justified by the size of the target audience and the level of interest and desire in the product or service that is created. Identifying and reaching the appropriate target audience is critical to creating a successful advertisement and developing a marketing campaign that delivers action by consumers.

Advertisements and marketing campaigns are individually crafted to appeal to specific audiences and their differing needs and desires. For example, television advertisements and commercials for the same product or service vary depending on the time of airing, the channel, and the expected demographics of the audience viewing the advertisement or commercial. Because of intense commercial competition, retail and service companies are continuously searching for new advertising and marketing ideas, more effective media for message delivery, and innovations that result in attention, interest, desire, and action with regard to the product or service being offered. Men are an important target of marketing campaigns.

One excellent location for capturing the attention of men for an advertisement is the men's restroom. The men's restroom is relatively free of competitive distractions, the target market is clearly identified and limited, and the cost to implement an advertisement is relatively inexpensive.

Relevant patents disclosing the use of urinals for the purpose of conveying information to the users of urinals include U.S. Pat. Nos. 5,809,590 and 5,867,848. Both of these patents disclose the use of thermochromic images or text messages to display unrevealed advertisements, pictures or information when a warm urine stream activates the thermochromic ink, causing the ink to convert from an opaque to translucent state, thus revealing an otherwise invisible image or text message. The process by which thermochromic ink converts from an opaque to translucent state is completely reversible with temperature reduction, which occurs when the urinal is flushed with cool rinse water. U.S. Pat. No. 5,809,590 discloses a urinal mat that contains a thermally-sensitive image or text message and reduces splash back by the incorporation of apertures and protrusions. In addition to displaying the image or text message upon activation, the mat serves to guide urine flow and prevent splash back. Such a device is large and expensive to produce and to change.

U.S. Pat. No. 5,867,848 discloses a display apparatus to present the image or text message. The disclosed apparatus is a urinal screen that is shaped such that the screen lies at the bottom of a urinal at a specific angle above the horizontal and above water level with said screen holding a thermochromic image or text message. Both of these patents disclose the use of larger devices to convey the displays. Disadvantages of these devices include the fact that they are large, bulky, and labor intensive and expensive to change.

Thermochromic ink has been used in numerous products to indicate temperature or to serve as a security indicator. For example, U.S. Pat. No. 5,820,951 discloses the use of thermochromic ink on a beverage can to display temperature. U.S. Pat. No. 5,389,093 discloses the use of thermochromic ink in baby diapers, which upon becoming wet, cause the appearance of printing on the surface of the diaper. U.S. Pat. No. 6,670,436 discloses the use of thermochromic ink to distinguish dental materials from natural dentin.

Athletic machines are used by many people with similar interests. Obviously, the need to exercise is one. Additional reasons are getting in shape, improving cardiovascular condition, meeting new people and even socializing. For a short time, at each machine, the individual is stationary, often looking around the room in boredom. No means of entertaining individuals (aside from TV) has been tried. Normally the machines are only decorated with the manufacturer's label. A method of providing a selective message to the user of the machine could benefit not only the user, but also the health club and other potential advertisers.

Boxes for the delivery of hot food often contain advertising messages (e.g., the name of the establishment) or just a “thank you.” Currently there is no way for the consumer to check the temperature of the hot food. There is a concern that the food may not have been maintained at a safe, high temperature. There is a need for an easy way for consumers, and even deliverers of the food, to determine that the food arrives at the proper temperature. An added advantage would be an easily changeable label for short term promotions. The label could be designed to appeal to children or other recipients. The present invention offers a solution to these needs.

### SUMMARY OF THE INVENTION

In one embodiment, a waterproof, thermally-sensitive label has several layers, including a waterproof plastic layer that is adhesive on its outer surface and printable on its inner surface, an advertising image printed on the inner base surface, a printable covering that overlays the advertising image. A layer of thermochromic ink is printed on the printable covering. The thermochromic ink is opaque at room temperature but is translucent at increased temperature. The top waterproof layer is selected to overlay and protect the thermochromic ink in a moist or wet environment.

In another embodiment, the thermochromic ink covers less than the entire label, so that at least one region of the label does not change when the thermochromic ink is activated by increased temperature. Optionally the thermochromic ink becomes translucent at increased temperature and becomes opaque after heat dissipates. Optionally the adhesive is applied to the base outer surface and binds firmly in a moist or wet environment but is readily removable. Optionally, the thermochromic ink is cured by ultraviolet light and is protected from the moist or wet environment with a waterproof overlay. Optionally, an unrevealed printed image or text message for use in moist or wet environments can be used in a urinal, a shower, a bathtub, a spa, a steam room or a toddler's commode. Optionally, the label displays advertising or public service messages. Optionally the label is affixed to a plurality of urinals to display advertising or public service messages.

Optionally, the polylaminate label has an unrevealed printed image or text message, thereby offering a cost-effective medium for advertising and/or marketing. Optionally the polylaminate label has an unrevealed printed image or text message in a less expensive, more adaptable, and highly competitive alternative.

In another embodiment, there is provided a method of advertising. The method of advertising begins with providing a label with a plastic layer that is adhesive on one surface and printable on its second surface; an advertising image or slogan printed on the printable surface, a printable covering that overlays the advertising image, a layer of printed thermochromic ink such that the thermochromic ink is opaque at room temperature but is translucent at increased temperature, and a clear plastic layer selected to overlay the thermochromic ink. The next step is placing the label in a urinal a short distance above the fluid level, but near the fluid level for the higher-temperature urine to contact the label; the final step is replacing the label periodically to coincide with new advertising campaigns.

Optionally, the label has an unrevealed printed image or text message that is an advertising and/or marketing tool for a specific audience. Optionally the provided polylaminate labels have unrevealed printed image or text message for a cost-effective medium for advertising and marketing.

Still other objects, advantages and distinctions of the invention will become more apparent upon reference to the following description and the appended drawings. The description should not be literally construed in limitation of the invention, but instead should be interpreted to include all equivalent constructions within the scope of the appended claims.

### BRIEF DESCRIPTION OF THE DRAWINGS

FIG. 1 is a cross section of the inventive sticker or label that shows five distinct layers, excluding the adhesive and its protective covering.

### DETAILED DESCRIPTION

The inventive labels have significant advantages compared to screens and mats in displaying advertisements in urinals. The smaller and less costly sticker or label can be replaced easily, which offers the advantage of readily changing advertisements without requiring relatively expensive labor of replacing mats or screens. The labels are placed on the back of the urinal, slightly above the base of the urinal or the screen/mat in the urinal. The inventive stickers or labels continue the appeal of the advertisement, maintain the interest of the target audience, adapt to changes and modifications in the marketing campaign, and change the product or service that is the subject of the advertisement. Because most individuals frequent the same eating and dining establishments repeatedly, the target audience would be exposed to the same advertisement repeatedly. By using the inventive stickers or labels in urinals, bars and dining establishments will be able to easily remove and reapply new advertisements with ease and without the difficulty of replacing large, costly screens or mats. In addition, the thermally-sensitive labels are suitable for use in a variety of urinals of differing configurations and sizes, because a proper fit is not required. This feature is critically important to support large marketing campaigns that would utilize a multitude of urinals of different sizes and configurations.

Besides urinals, thermochromic labels can be used in sinks, bathtubs, showers and health clubs to obtain the interest of both sexes. Labels in sinks can carry a message rewarding the washer with a picture or message encouraging hand washing.

This invention is a polylaminated, waterproof label for use in moist or wet environments that dynamically changes from displaying one image at ambient, room temperature or below to reveal a second, different image or text message; and the invention relates to marketing and advertising, specifically the use of thermally-sensitive labels in new, innovative media and locations.

The invention utilizes the properties of thermochromic inks. Thermochromic inks become translucent as their temperature increases. These color-changing inks all work the same way: below the activation temperature they are colored, and above the activation temperature they are clear or lightly colored. As the ink cools, the original color returns. Low temperature ink is used for applications in the refrigeration temperature range, like beverage labels and ice-cream packaging. Body temperature ink is designed to show color at normal room temperature and to change when rubbed with the finger or by breathing on it. It is used on packaging and other interactive products. High temperature formulation changes color just below the pain threshold temperature for skin, and is used on safety labels, microwaveable products, and hot beverage labels. Thermochromic inks are available from Chromatic Technologies, Inc. (Colorado Springs, Colo.), H.W. Sands Corp. (Jupiter, Fla.) and other manufacturers.

The invention requires a plastic to water-proof the label to prolong the life of the label in wet environments. The plastic also needs to be clear to allow the underlying colors to show. Clear plastics include polyvinyl chloride, polyurethane, low density (LD) polyethylene, high density (HD) polyethylene, polystyrene, polypropylene and polyester. Some of these plastics are sufficiently waterproof at increasing thicknesses. These plastics are available from a variety of manufacturers.

An adhesive is necessary to position and maintain position of the label on porcelain, steel and other surfaces that one might want to use. Also the adhesive must be easy to remove, so that the label can be quickly replaced, preferably without the use of a solvent. A variety of adhesives are available from general chemical manufacturers as well as specialty houses. Adhesives also are available from distributors who provide adhesives from a variety of manufacturers. For steel surfaces, an alternative way to maintain the position of the label incorporates the use of magnetic patches or strips. The entire surface or only a portion of the label backing can be covered with the magnetic patch.

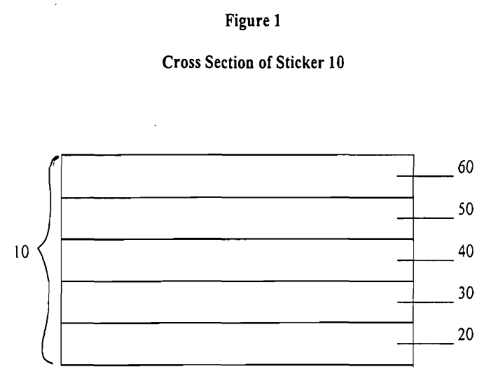

The invention is a polylaminated, waterproof label for use in moist or wet environments that utilizes thermochromic ink such that the label displays one image in its opaque state, and upon warming, reveals a second, different image or text message when the thermochromic ink is activated to its translucent state. The label 10, in its preferred embodiment, is composed of five layers, as shown in FIG. 1. The base of the label or label is a plastic layer 20, to which a waterproof adhesive and a removable protective cover are added. The base may be comprised of vinyl, polypropylene, white film facestock or other suitable materials. The second layer is a printed image or text message 30 which is revealed only when the overlying thermochromic ink dynamically changes from an opaque color to translucent when exposed to a higher temperature. This image or text can be printed using a variety of inks. The third layer is a protective cover 40, composed of various materials. The fourth layer 50 is an image printed with thermochromic ink selected by one skilled in the art to dynamically change from opaque to translucent upon exposure to a predetermined higher temperature. The ink used in this invention is opaque at ambient, room temperature and translucent at higher temperatures, such as body temperature (98.6° Fahrenheit or 37° Celsius). The fifth layer 60 is a thin, waterproof covering that protects the thermochromic ink and the label in moist or wet environments.

The inventive labels are suitable for use in urinals to promote specific products or services by displaying images or text messages when activated by warm urine. Alternatively, the inventive labels can be used to display public service messages, such as positive feedback for hand washing. The use of heat-sensitive labels in urinals is an extremely interesting and innovative concept that has not previously been exploited or disclosed.

The inventive sticker or label preferably is installed in the optimum location of a urinal to reduce splash back and improve cleanliness of the urinal and its environment. Urinals are designed with a concave back wall that the urine stream should hit to contain urine and minimize splash back. The label is installed at this optimum location and creates a target for users. The man directs his urine stream at this target, thereby reducing urine splash back, which results in improved hygienic conditions and cleaner restrooms.

The labels are placed on the back walls of urinals, thus creating targets at which the urine stream is directed.

When a man approaches the urinal, he will immediately notice the label, as it will be displayed in the conspicuous location where men will immediately direct their attention. When the man begins to urinate, the heat of the urine stream, which approximates body temperature (98.6° Fahrenheit or 37° Celsius), activates the thermochromic label, which becomes clear to reveal a second underlying image and/or text message. When the man has completed urinating, the act of flushing the urinal with cool water cools and cleans the label and returns the thermochromic ink to its opaque state, ready for the next man. The dynamic change in the appearance of the label captures the man's attention, retains his interest through personal interaction with the dynamic effects of the invention, and creates a highly positive and lasting impression from the innovative changes in the label.

The application of the inventive labels is not limited to urinals. The labels can be used in any moist or wet environment with changing temperatures. For example, the inventive labels can be applied in showers, bathtubs, non-slip shower mats and to shower curtains or doors where the label is opaque at ambient temperature but reveals a second image or text message when the translucent state is induced by contact with steam or warm water. Thus, the dynamic change from an opaque to translucent state occurs while the shower is in use. Likewise, the labels are ideal for placement in spas and steam rooms.

In another embodiment, there is a method of providing thermochromic labels with two appearances to people who provide athletic equipment, such as spas and health clubs. There would be 100% exposure to people using the equipment. Some of the advantages include targeted advertising, creative reminders, and product or service promotion. When people sit or lie on the equipment, they heat certain parts of the equipment. Those parts could accommodate room temperature images most of the time and warmer temperature images when people use the equipment. Such a label could be used by health club management to impart messages such as “wipe machine when finished” for the warmer image and an advertising message such as exercise garments for the room-temperature image. To maintain esthetics, the label could alternately be blank at room temperature but display a message when heated. Messages on behalf of the health club could promote in-house training and classes. Depending on the type of exercise machine, usage may be primarily confined to males or females. In that circumstance, messages can be tailored to the gender of the user for even more narrowly targeted advertising. In addition, beginners frequently start with training-circuit machines. Special messages to that group also could be designed. Preferably, the thermochromic labels can be easily removed to make way for the next promotion.

In another embodiment, there is provided a method for monitoring the temperatures of food containers, such as pizza boxes, Chinese food containers and everything in between. The thermochromic label is designed to carry one message at room temperature (e.g., the name of the establishment) and another message at the advisable higher temperature indicating that the food is ready to eat. An important concern of an establishment that delivers food is speed that permits the product to arrive at the advisable temperature. Instead of opening the container (that allows heat to escape quickly), diners could use the thermal label to show the heat of the container. The innovative labels also allow for creative advertising messages that can display the temperature of the food and quality of the service. Preferably, the labels have amusing messages, can be removed and placed at a different location.

This example is not intended to limit the scope of applications for this invention, but rather is presented to exemplify how one of ordinary skill in the art can study this invention, including the description and the accompanying drawings, and identify other applications, modifications, and advantages. For example, the label can be formed of a variable number of layers, some of which are printed, and others are clear.

1. A polylaminated, waterproof, thermally-sensitive label comprising
a. a waterproof plastic base that is adhesive on its outer surface and printable on its inner surface;
b. an advertising image printed on the inner surface;
c. a printable covering that overlays the advertising image;
d. a layer of thermochromic ink on the printable covering such that the thermochromic ink is opaque at room temperature but is translucent at increased temperature; and
e. a waterproof overlay less than the entire label, such that at least one region of the label does not change when the thermochromic ink is activated by increased temperature.

2. The polylaminated label of claim 1, wherein the thermochromic ink, having become translucent at increased temperature, becomes opaque after heat dissipates. The polylaminated label of claim 1 wherein an adhesive is applied to the base outer surface and is covered by a non-stick material.

3. The polylaminated label of claim 1, wherein the adhesive binds firmly when exposed to heat but is readily removable.

4. The polylaminated label of claim 1, wherein the thermochromic ink has been cured by ultraviolet light.

5. The polylaminated label of claim 1, wherein the label displays an advertising or public service message.

6. The polylaminated label of claim 5, wherein the label comprises an unrevealed printed image or text message suitable for affixing to exercise equipment.

7. A method of advertising in gyms and health clubs featuring exercise equipment, the method comprising
providing a label comprising a plastic layer that is adhesive on one surface and printable on its second surface, an advertising image or slogan printed on the printable surface, a printable covering that overlays the advertising image, a layer of printed thermochromic ink such that the thermochromic ink is opaque at room temperature but is translucent at increased temperature, and a waterproof layer selected to overlay the thermochromic ink; and
b. placing the label on exercise equipment in a location where it will be heated by the body of the exercising individual.

8. The method of claim 7, wherein the label is easily removable.

9. The method of claim 7, wherein the label is replaced periodically to coincide with new advertising campaigns.

10. A method of determining the temperature of a food container, the method comprising
providing a label comprising a plastic layer that is adhesive on one surface and printable on its second surface, an advertising image or slogan printed on the printable surface, a printable covering that overlays the advertising image, a layer of printed thermochromic ink such that the thermochromic ink is opaque at room temperature but is translucent at increased temperature, and a waterproof layer selected to overlay the thermochromic ink; and
placing the label on the food container in a location where it will receive heat from the food therein;
wherein the opaque thermochromic ink becomes translucent at the required temperature of the food container, thereby indicating a safe eating temperature.

11. The method of claim 10, comprising the additional initial step of designing the label so that it displays different messages when at room temperature and the required container temperature.

12. The method of claim 10, wherein the cooled label displays an amusing message.

13. The method of claim 10, wherein the label is easily removable.
